(19) United States
(12) Patent Application Publication
(10) Pub. No.: US 2012/0239504 A1
(43) Pub. Date: Sep. 20, 2012

(54) Virtual Shopping Assistance

(75) Inventors: John Curlander, Boulder, CO (US); William B. Gail, Boulder, CO (US); Heinrich Frick, Boulder, CO (US)

(73) Assignee: MICROSOFT CORPORATION, Redmond, WA (US)

(21) Appl. No.: 13/047,907

(22) Filed: Mar. 15, 2011

(51) Int. Cl. G06Q 30/00

(52) U.S. Cl. 705/14.66

(57) ABSTRACT

On-premise virtual shopping assistance is provided via a mobile device and other networked user interface devices. The assistance can be based on various context parameters associated with the shopper, including without limitation location, past shopping behavior, shopping list content, store layout, inventory, social networking characteristics, in-store activity, perceived shopper intent, etc. Based on such context information, a retailer and/or a manufacturer can provide relevant information to an on-premise shopper, including without limitation product/service promotions (e.g., discounts), product/service specifications (e.g., nutritional information) and recommendations and on-premise routing information. Such information may be presented to the user through a mobile device or via on-premise displays that respond to the shopper's location within a store. In one implementation, on-premise virtual shopping assistance may be provided through a cross-retailer shopping platform that integrates shopper, product/service, and retailer information and presents relevant assistance to the shopper through one or more user interfaces.

### BACKGROUND

Online shoppers have grown accustomed to accessing detailed product information relating to their interests, search queries, locale, etc. Product recommendations, product specifications, discount/rebate offers, new product announcements, and other information can be personalized for each online shopper based on information an online retailer can collect about the online shopper, such as past shopping behavior, product preferences, etc. Such information can enhance the shopping experience and value for both the online shopper and the online retailer, particularly because such information engages the online shopper at the point-of-decision during his or her online shopping activity.

However, in-store shoppers do not generally receive such rich, targeted information. Instead, brick-and-mortar retailers typically present an in-store shopper with product information directed to all in-store shoppers, regardless of a shopper's individual purchase history, interests, etc. For example, a retailer may display promotional information in a store aisle to attract the attention of a shopper who may be interested in diapers. Unfortunately, if a shopper with no children passes by the promotional display for diapers, the promotional information is of little or no value to either party—the retailer may have lost an opportunity to provide a different, more relevant advertisement to the shopper (e.g., washing detergent), and the shopper may have lost an opportunity to consider a valuable discount or new product. Other types of interaction between retailers and in-store shoppers, such as coupons clipped from a newspaper or circular and radio/television commercials, are also less than optimal, particularly because they fail to engage the shopper at the point-of-decision (e.g., in the store). Accordingly, “on premise” retailers and shoppers lack the rich and relevant interaction available to online retailers and shoppers.

### SUMMARY

Implementations described and claimed herein address the foregoing problems by providing virtual shopping assistance, such as via a mobile device or other networked user interface devices. The assistance can be based on various context parameters associated with the shopper, including without limitation location, past shopping behavior, shopping list content, store layout, inventory, social networking characteristics, in-store activity, perceived shopper intent, etc. Based on such context information, a retailer and/or a manufacturer can provide relevant information to an on-premise shopper, including without limitation product/service promotions (e.g., discounts), product/service specifications (e.g., nutritional information), product/service recommendations, and on-premise routing information. Such information may be presented to the user through a mobile device or via on-premise displays that respond to the shopper's location within a store. In one implementation, virtual shopping assistance may be provided through a cross-retailer shopping platform that integrates shopper, product/service, and retailer information and presents relevant information to the shopper through one or more user interfaces. Assistance can be provided to on-premise shoppers as well as shoppers who are “virtually” in the store, such as through an online communication connection. Furthermore, assistance can be provided to individuals who are not shopping but are otherwise visiting an establishment, such as a museum, amusement park, sporting event, etc.

In some implementations, articles of manufacture are provided as computer program products. One implementation of a computer program product provides a tangible computer program storage medium readable by a computer system and encoding a computer program. Other implementations are also described and recited herein.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTIONS OF THE DRAWINGS

FIG. 1 illustrates an example system for non-premise virtual shopping assistance.

FIG. 2 illustrates an example user interface for an on-premise virtual shopping assistance client application.

FIG. 3 illustrates an example cross-retailer network connecting manufacturers, retailers, and shopping clients for on-premise virtual shopping assistance.

FIG. 4 illustrates an example system for providing on-premise virtual shopping assistance.

FIG. 5 illustrates an example initial phase for determining shopper intent.

FIG. 6 illustrates an example subsequent phase for determining shopper intent.

FIG. 7 illustrates yet another example subsequent phase for determining shopper intent.

FIG. 8 illustrates a detailed architecture of an example on-premise virtual shopping assistance system.

FIG. 9 illustrates an example promotional offer interface.

FIG. 10 illustrates another example promotional offer interface.

FIG. 11 illustrates example operations for providing on-premise virtual shopping assistance.

FIG. 12 illustrates an example system that may be useful in implementing the described technology.

FIG. 13 illustrates another example system that may be useful in implementing the described technology.

### DETAILED DESCRIPTIONS

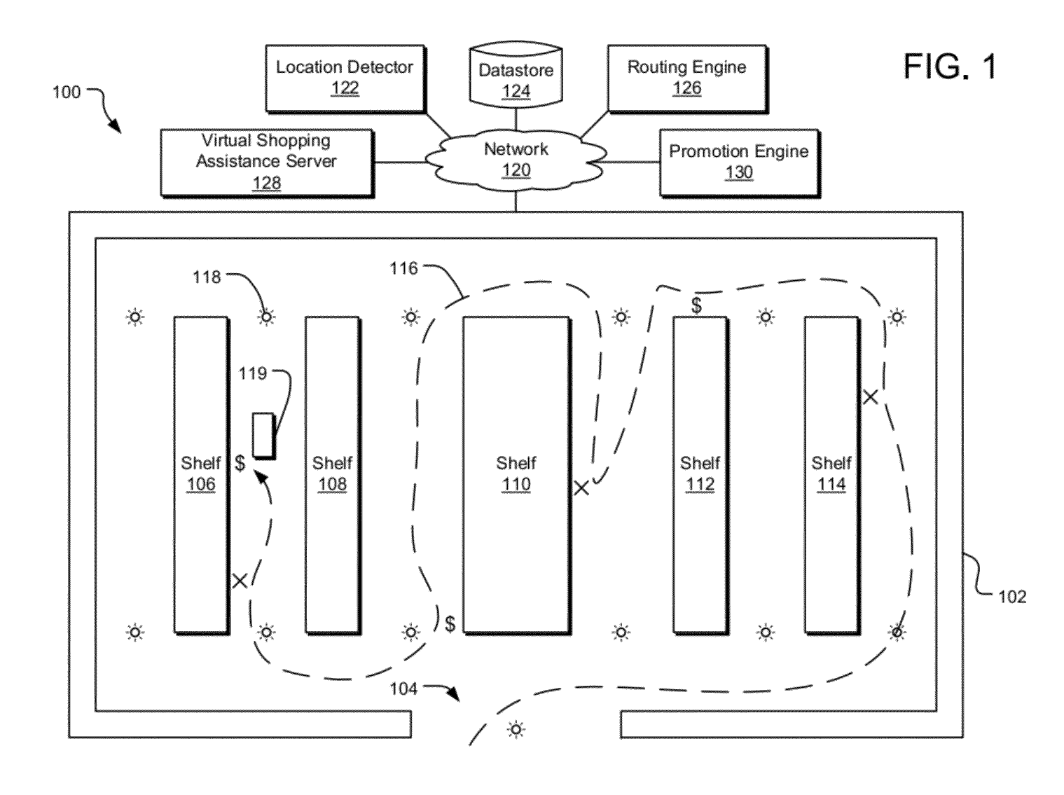

FIG. 1 illustrates an example system 100 for on-premise virtual shopping assistance. A layout 102 depicts a mapping of an on-premise retail establishment, with an entry/exit 104 and aisles separated by display shelves 106, 108, 110, 112, and 114. The layout 102 may, for example, be shown on a personal mobile device (e.g., a smartphone), a display on a grocery cart, etc. The layout 102 also shows a proposed route 116 suggested to a shopper to follow through the on-premise retail establishment. In one example, the shopper may have entered a shopping list into a website associated with the establishment, and based on the shopping list, the shopper is shown a proposed route 116 through the establishment to find the items on the shopping list (e.g., the location of each item is marked with an “x” on the layout 102). This routing functionality represents one example of virtual shopping assistance in an on-premise shopping establishment.

On-premise refers to a physical presence of the shopper at or near the physical shopping location or within a physical shopping establishment (e.g., a brick-and-mortar retail store). In addition, assistance can be provided to on-premise shoppers as well as shoppers who are “virtually” in the store, such as through an online communication connection, assistance can be provided to visitors who are not shopping but are otherwise visiting an visited establishment, such as a museum, amusement park, sporting event, etc. To provide virtual shopping assistance in an on-premise situation, one or more different kinds of “context” may be material to the assistance provided to an on-premise shopper as compared to an online shopper, including the physical location of the shopper, the layout of the establishment, and the physical location of individual product items or service points. For example, the proposed route 116 may be based on items from a shopping list (e.g., entered into a website by a shopper), the layout of the store, an inventory of product items on hand, the locations of such items, and the real-time location of the shopper within the store.

These context parameters can be used by the on-premise virtual shopping assistance system 100 to provide relevant information, such as the proposed route 116, to the on-premise shopper. Other relevant information may include promotional information (e.g., real-time, in situ coupons), suggested recipes that include items along the shopper's route, suggesting additional products that are not on the shopper's list but would go well with items on the list, etc. Further, if the shopper diverges from the proposed route 116 or changes items on his or her current shopping list, the on-premises virtual shopping assistance system 100 can update accordingly and present a modified proposed route based on the real-time position of the shopper.

In one implementation, the on-premise virtual shopping assistance system 100 determines the real-time location of the shopper based on a distributed set of reference points (e.g., such reference point 118) and a mobile shopper client device 119, such as a uniquely identifiable smartphone or other client device, a virtual shopping assistance client device in a shopping cart, etc. The mobile shopper client device 119 may or may not include a presentation interface, such as a display or audio output.

In one implementation, the reference points 118 are networked through a network 120, which may be a wired network, a wireless network or a combination of the two, with various sub-systems of the virtual shopping assistance system 100, such as a location detector 122, a datastore 124, a routing engine 126, a virtual shopping assistance server 128, and a promotion engine 130. In such an implementation, the mobile shopper client device 119 emits a signal detectable by the reference points 118, which send monitored signal strengths to the location detector 122. The location detector 122 then determines real-time location of the mobile shopper client device 119 based on the relative signal strengths, such as by using triangulation in relation to the reference point locations within the store layout.

In other implementations, the reference points 118 are active beacons that the mobile shopper client device 119 monitors to determine its location within or near the establishment. In one such implementation, the mobile shopper client device 119 monitors relative strengths of signals received from each reference point 118 and determines its real-time locations based on the signal strengths, such as by using triangulation in relation to the reference point locations within the store layout. Other location detection techniques may also be employed.

Likewise, the mobile shopper client device 119 may also be networked through the network 120 to one or more of the sub-systems of the virtual shopping assistance system 100. In one implementation, the network 120 may represent a portion of the Internet, although more restrictive networks (e.g., an intranet) or networks of alternative protocols and physical communication technologies may also be employed.

In various implementations, the virtual shopping assistance client application operates in the mobile shopper client device 119 (e.g., executing in the device 119 or on a virtual shopping assistance server that interacts with the shopper through the mobile shopper client device 119). The mobile shopper client device 119 can assist the shopper to perform various actions, including without limitation: (1) creating and using shopping lists; (2) obtaining information about retailer products/services (e.g., showing the location of such products/services and a route to them); (3) searching for products (e.g., by keyword, brand name, product category, prices range, etc.); (4) scanning barcodes or otherwise identifying a product/service to get product/service information (e.g., related pricing, product specifications, service terms and condition, available promotions, product/service comparisons, reviews, recommendations, etc.); (5) obtaining information about promotions (e.g., sorted by category, establishment, date, proximity, etc.), and other shopping-related actions. In some implementations, the virtual shopping assistance client application may also have various versions that allow the shopper to access the virtual shopping assistance (e.g., the shopping list functionality) through alternative devices, such as a desktop computer at home.

In one implementation, the datastore 124, which may be a collection of multiple distributed datastores, includes one or more of a store layout, inventory information, product pricing, promotional information, product/service locations, personalized shopper information, manufacturer information, etc. Such data may be accessed by the location detector 122, the routing engine 126, the virtual shopping assistance server 128, the promotion engine 130, and the virtual shopping assistance client application to record and access shopping-related context parameters.

Turning to specific components of the implementation of FIG. 1, the location detector 122 processes the shopper location information (e.g., relative signal strengths or computed location data) received from the distributed beacons or the mobile shopper client device 119. By combining the shopper location information with the store layout, the location detector 112 maintains the current real-time location of the shopper relative to other locations in the establishment and potentially relative to individual products on display within the establishment. The real-time location information can be communicated directly to other components of the virtual shopping assistance system 100, stored in the datastore 124, or communicated to other systems.

By real-time tracking the shopper (e.g., via the mobile shopper client device 119) through the establishment and knowing where product items are placed within the layout 102, the virtual shopping assistance system 100 can determine where the shopper is relative to individual product items. With this information, the virtual shopping assistance system 100 can offer specialized promotions based on the shopper's location, nearby products, etc. For example, if the virtual shopping assistance system 100 detects that the shopper is in the snack food aisle, the virtual shopping assistance system 100 can analyze the shopper's past purchase behavior to personalize a promotion for that shopper. In one scenario, the virtual shopping assistance system 100 can determine that the shopper is a regular purchaser of a medium bag of a particular brand of Bavarian sourdough pretzels. Accordingly, based on the available promotions established by the retailer or one or more snack wholesalers or manufacturers, the virtual shopping assistance system 100 may send a message to the shopper's mobile shopper client device 119 offering the shopper a discount on a large bag of the same product. Alternatively, the virtual shopping assistance system 100 may send a message to the shopper's mobile shopper client device 119 offering the shopper a discount on a competing bag of pretzels. In contrast to the typical broadcast or untargeted promotional mechanisms, the virtual shopping assistance system 100 can fine-tune the promotional messages based on context information about the shopper, the retailer's (or wholesaler's) inventory and/or product flow, and the manufacturer incentives available to the retailer. For the shopper, he or she has a better chance of being offered and taking advantage of a promotion of interest.

The routing engine 126 processes the real-time location information in combination with other information, such as store layout information, inventory, product placement information, promotional information, shopping list information, etc. to compute an efficient route through the establishment, assisting the shopper to find the products of interest quickly, without searching for the items or backtracking to find the next item on his or her list.

The promotion engine 130 maintains promotional information pertaining to product items and manages the use of promotions through the virtual shopping assistance server 128. In some implementations, the promotional engine 130 may obtain such data directly from one or more external systems maintained by the retailer, wholesalers, manufacturers, etc., although in other implementations, the promotional information is recorded in the datastore 124. By combining the promotional information with the shopper's past shopping behavior and real-time location, the promotional engine 130 can determine when and where (as depicted as the “$” in FIG. 1) to present a personalized promotion to the shopper, what the magnitude of the promotion is (e.g., some shoppers may traditional react to smaller incentives than others), and how the shopper responded to the promotion, if at all (e.g., did the shopper accept of the promotion?).

The virtual shopping assistance server 128 manages the various components of the virtual shopping assistance system 100, including the presentation of information to the shopper through the mobile shopper client device 119 and the processing of shopper interaction (e.g., shopping lists, responses to promotional opportunities, etc.). Various phases of the assistance process, including data sourcing, staging, delivery, display, redemption, and feedback are described with regard to other figures.

As an alternative or in addition to a mobile user interface device providing virtual shopping assistance based on the identity and real-time location of the shopper, the retailer can place interactive devices through the store. For example, the snack aisle may include one or more floor-based or shelf-attached user interface devices that display personalized messages to shoppers in their proximity. For example, a shelf-attached device position near the pretzels may flash a coupon that is personalized for the nearby shopper's purchasing habits (e.g., “Large bag of BrandX pretzels—Save 50 cents at check out!”). The identity of the shopper can be synchronized with the coupon via a scan of the shopper's loyalty card at both the coupon display and a point-of-sale system.

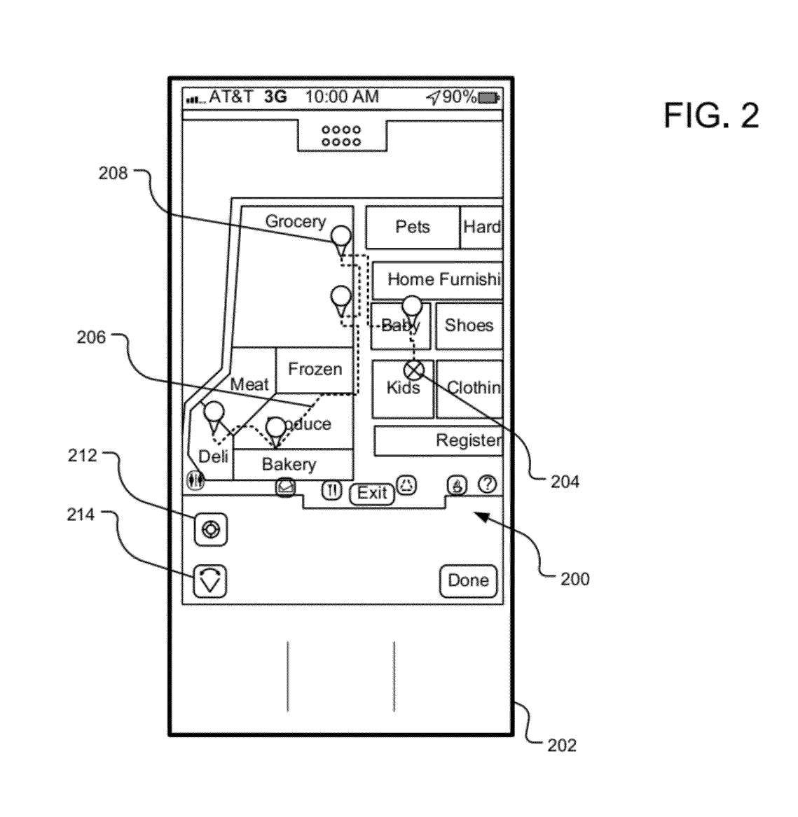

FIG. 2 illustrates an example user interface 200 for an on-premise virtual shopping assistance client application. The user interface 200 is depicted as being displayed in a mobile device 202, such as a smartphone or a shopping cart-based display. However, it should be understood that user interfaces may be distributed throughout an establishment to display promotional information and other product information when a particular shopper is in the proximity.

The user interface 200 shows a map graphic with a variety of product groupings (e.g., groceries, pet supplies, shoes, baked goods, cash registers, restrooms, etc.). The current location of the shopper is marked with an “x” in a circle 204. A proposed route 206 is shown in a dashed line, with locations of items on the shopper's shopping list or items suggested by the virtual shopping assistance system marked with icons (such as icon 208).

At any location in the establishment, a virtual shopper assistance server can present a promotional offer to the shopper via the user interface. For example, in the mobile device 202 may chime and change its display to show a digital coupon offering the shopper a discount of 50 cents if the shopper purchases a nearby product item. The user can accept or decline the promotional offer via the mobile device 202, and the discount can be credited to the shopper at a point of sale system. Alternatively, the promotional offer can be presented to the shopper at a store-based display (e.g., in the aisle or on a shelf). Such displays may also receive shopper responses, accepting or declining the promotional offer.

The user interface 200 includes a tracking control 212, which toggles a tracking function that keeps the map centered on the shopper's real-time position, and a heading control 214, which toggles the operation of the electronic compass in the mobile device.

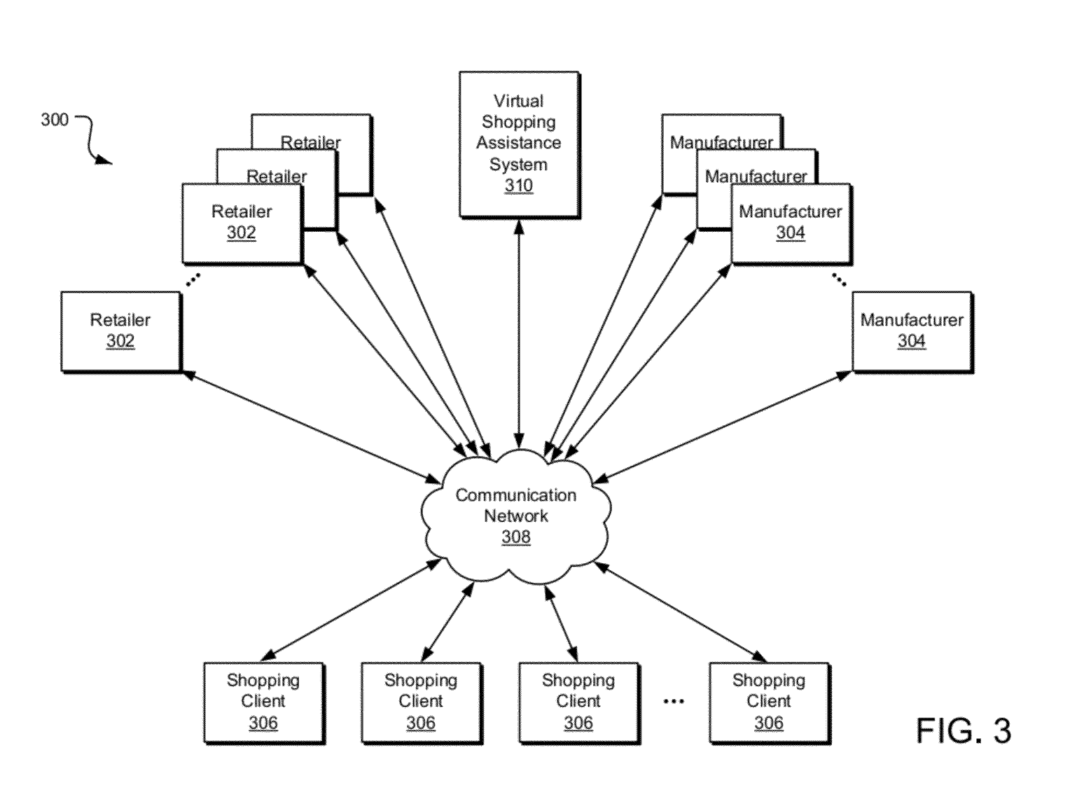

FIG. 3 illustrates an example cross-retailer network 300 connecting manufacturers 304 (or consumer packaged goods (CPG vendors)), retailers 302, and shopping client systems 306 for on-premise virtual shopping assistance. The various systems are communicatively coupled by one or more communication networks 308.

In contrast to dedicated applications for each retailer, the cross-retailer network 300 allows multiple disparate retailers to use a common virtual shopping assistance system 310 and potentially the common virtual shopping assistance application installed on a shopper's mobile device. In this manner, the shopper obtains virtual shopping assistance in any participating retail establishment through a common interface, where the appropriate retail establishment is identify based on the shopper's location (e.g., on the retailer's premises or in the proximity of a specified location). Furthermore, based on the location-based identification of the retailer, the common application can be slightly stylized or specialized with retailer-specific customization, such as logos, special functionality, and retailer-specific data.

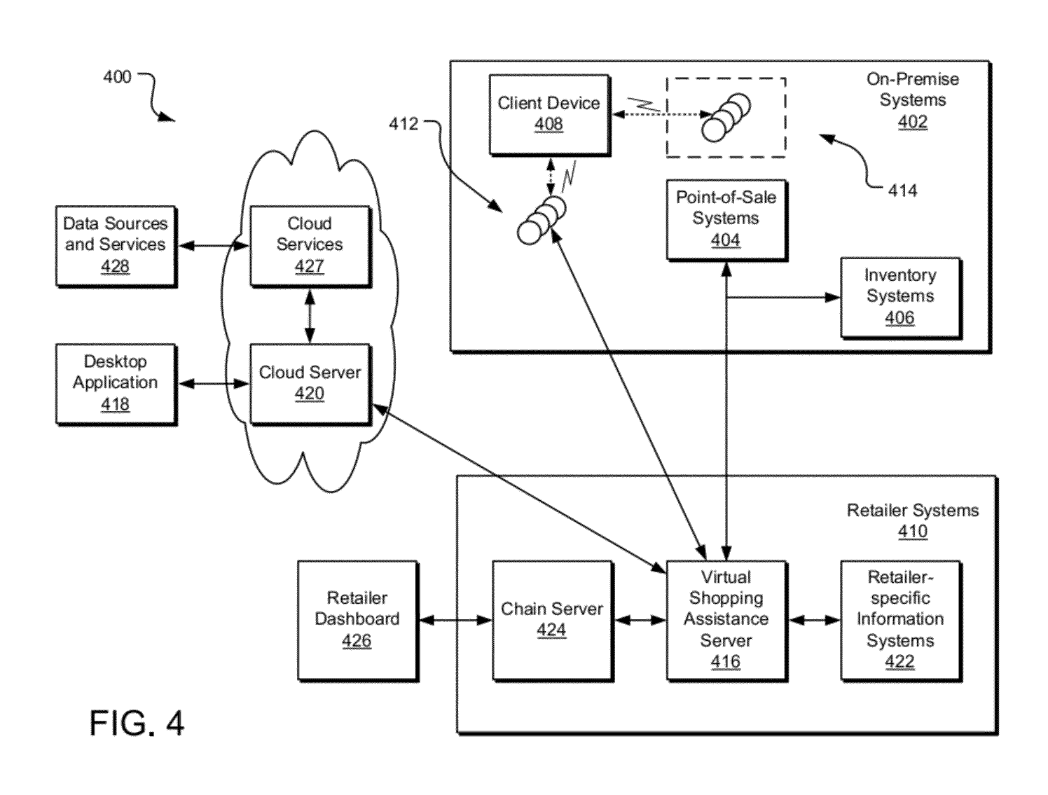

FIG. 4 illustrates an example system 400 for providing on-premise virtual shopping assistance. In the illustrated implementation, on-premise systems 402 include one or more point-of-sale systems 404 (e.g., manned or self-serve check out terminals), inventory systems 406, and at least one client device 408 providing a user interface to the virtual shopping assistance system. The point-of-sale systems 404 and inventory systems 406 are communicatively coupled to the retailer's information technology systems 410, which may be on-premise or off-premise. The client device 408 executes or presents a user interface to a virtual shopping assistance application through which the user can receive shopping assistance and interact with the system 400. The client device 408 communicates through on-premise wireless network access points 412, and the real-time location of the client device 408 can be tracked by a separate wireless tracking reference points 414, although in some implementations, the access points 412 and the reference points 414 may be integrated into a common set of access/reference points.

A virtual shopping assistance server 416 resides in or is communicatively coupled to the retailer systems 410 and manages the shopping assistance provided to the shopper through the client device 408 and through a desktop application 418, which the shopper can use to access the virtual shopping assistance server 416 via a cloud server 420 (e.g., to create a shopping list, review receipts, perform product research, etc. at home). The virtual shopping assistance server 416 can also access retailer-specific information systems 422 to obtain product information (e.g., product details, pricing, inventory, etc.), store information (e.g., store layout, retailer-specific services, etc.), and user information (shopping lists, eligible coupons and other promotions, etc.). Information common to all retail establishments in a chain may be obtained via a chain server 424, which integrate with the chain/store enterprise systems to receive ongoing updates of relevant information (e.g., product recalls). The virtual shopping assistance server 416 also tracks information about which coupons a shopper has selected for redemption and communicates this information to the appropriate store systems, such as the point-of-sale systems 404 to effect the appropriate promotion-related discounts, etc. The chain server 424 and the virtual shopping assistance server 416 are communicatively coupled to a retailer dashboard system 426 to all retailer and chain personnel to monitor and manage interactions with shoppers (e.g., to track shopper traffic, the popularity of certain promotions, the interest in specific products, etc.). The virtual shopping assistance server 416 is also communicatively coupled through the cloud server 420 and assorted cloud services 427 to external data sources and services 428, which provide functionality and content common to all participating retailers, such as product imagery, product reviews and recommendations, social network communications and data, Web search content, etc.

The virtual shopping assistance system 400 supports the concept of a retail chain that owns one or more retail stores, although this concept can be expanded to include independent stores in a shopping mall, a family of amusement parks, a group of public or private museums, etc. In one implementation, the system 400 may record without limitation attributes such as:

Chain Attributes
Name (e.g., “ABC Chain”)
Category (“e.g., “Home Improvement,” “Grocery,” “Pharmacy,” “Art Museum”)
Logo Image
Other mobile application customization parameters (e.g., background image, navigation tab colors, foreground colors, background colors)
Headquarters address
Contact person (e.g., name, email address, fax number, telephone number)

Store Attributes
Name (e.g., “Boulder 29^{th} Street Mall”)
Address
Store hours
List of floors
Chain's identification of this store (e.g., a chain's own identifier “216”)
Time zone
Currency

In addition, each store can be configured with additional features, including without limitation a list of Points of Interest location in the store (e.g., “Restrooms,” “Security”) or a list of chain hosted web sites. The geospatial information for each store (e.g., store layout, department locations, aisles information, shelf information) can also be recorded as store attributes.

In one implementation, the system 400 provides two different administration roles to a retailer for management of the retailer's assets, although other configurations may be employed. A “chain admin” provides overall administration of the retail chain's assets. A “store admin” provides administration to a specific retail store, which may have several store admin's configured in the system 400. A chain admin can create and manage a store admin account within the associated chain's stores. Initial administrator credential information may include without limitation, a user name, a password, a retail chain identifier, a URL of the retail chain web site, and one or more recovery email addresses. In one implementation, the domain of a recovery email address matches the domain of the retail chain web site, although this constraint is optional. When a new retail chain is configured, an email is sent to the recovery email address with a URL to the retail chain dashboard, so that the chain admin can continue to configure the retail chain and associated stores through the retail chain dashboard. Among other features, the retail chain dashboard can allow an admin to manage product/service categories, map categories to locations, manage stores, manage product abbreviations and configuration parameters, manage category keywords, search products, and manage promotions.

The system 400 communicates with the retail chain infrastructure via a variety of communications channels (also called data feeds), which are configured for daily operation. Example data fees between the system 400 and a retail chain infrastructure may include
Product Master Interface
Produce Detail Update Interface
Offer Detail Update Interface
Offer Clip Action Interface
Transaction Details Interface (e.g., electronic receipts)

Examples of the above-referenced interfaces are given below, although additional or fewer interface characteristics may be employed:

Product Master Interface
Channel style: sftp (SSH File Transfer Protocol) pull
Format: XML file
Update frequency: 1-5 times a week
Instances: one per chain
Base file name: PM
Fields (examples):
   Product ExternalID
   Universal Product Code (UPC)
   Name
   Description
   Category

Product Detail Interface
Channel style: sftp pull
Format: XML file
Update frequency: 1-4 times per day
Instances: one per store
Base file name: PD
Fields (examples):
   Product ExternalID
   Universal Product Code (UPC)
   Product Location Code (PLC)
   In-stock quantity
   Price

Offer Detail Interface (i.e., for Promotions)
Channel style: sftp pull
Format: XML file
Update frequency: 1-5 times per week
Instances: one per chain
Base file name OD
Fields (overview)
   Offer ExternalID
   Universal Product Code (UPC)
   Name
   Description
   Discount Type
   Discount Value
   List of applicable product UPCs

Offer Clip Action Interface
Channel style: sftp pull
Format: JSON or XML
Update frequency: for each offer clip action
Fields (overview)
   ExternalID
   Universal Product Code (UPC)
   User LoyaltyID
   Clip action (e.g., “Clip” or “Unclip”)

Transaction Details Interface
Channel style: sftp pull
Format: XML file
Update frequency: 1-5 times per week
Instances: one per chain
Base file name TD
Fields (overview)
   Transaction ExternalID
   Store ExternalID
   Transaction date and time
   Register number
   User LoyaltyID
   Total number of items
   Total transaction gross amount
   Total transaction net amount
   Total savings amount
   List of
      Product ExternalID
      Product UPC
      Quantity type
      Quantity count
      Retail price per item
      Paid price
      List of Offer ExternalIDs applied
      isReturn flag

Some of the data interfaces transport large amounts of data. As such, in one implementation, the virtual shopping assistance system 400 uses sftp pull of XML files, although other data transport mechanisms may be used. The retailer dashboard 426 allows configuration of an sftp connection between the virtual shopping assistance system 400 and the retailer. The following example attributes can be set, although other attributes may be used.
Hostname and path (e.g., “sftp://ftp.abc_retailer.com/vshoppingassist”)
Username
Password

In addition, a pull frequency of each communication interface can be set by specifying the week day and time of day (e.g., in UTC time zone) for the virtual shopping assistance system to pull the requested files, a number of retries, and a retry interval (e.g., in minutes).

Relatively precise product locations can be represented in a product locus item, specifying a 4″ section of shelving in most cases, although end-caps and freezer cases may also be specified. The product locus items may be imported into the virtual shopping assistance system 400 via a CAD file in the JDA format, using the retailer dashboard. Each of the product locus items is characterized by attributes, including without limitation:
Zone (e.g., department)
Aisle name or number
Section (e.g., an ID for the 4″ section or product locus item)

The set of attributes listed above have also been termed a “Product Location Code” (“PLC”).

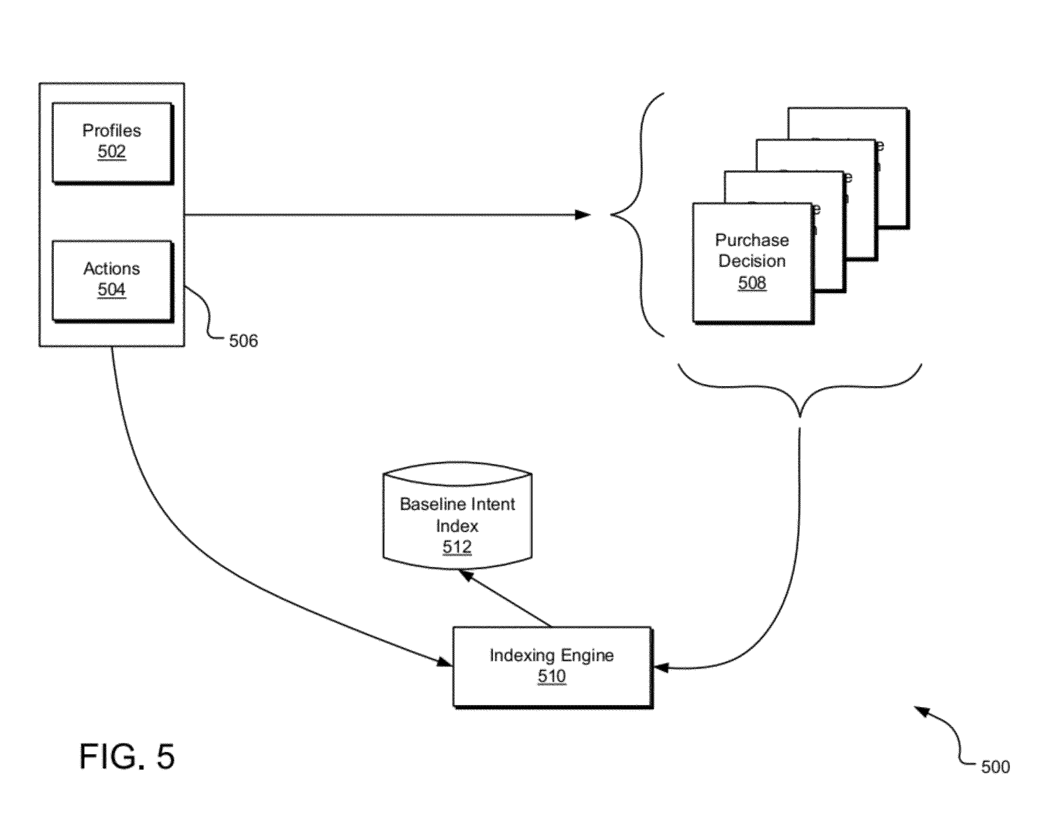

FIG. 5 illustrates an example initial phase 500 for determining shopper intent. Profiles 502 and actions 504 are stored in a datastore 506, which may be stored locally at the retailer, remotely, or in a distributed fashion. A profile 502 stores information pertaining to a shopper, including without limitations examples such as the shopper's product/service search history, a shopper's personal profile information (e.g., name, address, frequent shopper's card number), shopping characteristics (e.g., frequent visits, days of week for visits, payment by credit card or cash, previous routes through store), basket history (e.g., records of past purchases), promotions history (e.g., records of past promotions offered, accepted, and declined), etc. An action 504 represents monitored events pertaining to the shopper's interactions with a virtual shopping assistance system, including without limitations examples such as search-related keywords (e.g., for recent searches performed in relation to the current shopping visit), trigger times (e.g., when a shopper triggers a promotional offer), shopper location (e.g., a real-time tracking of the shopper's location during the in-store visit), shopping list-related keywords (e.g., keywords associated with a shopper's shopping list, which may be entered into the virtual shopping assistance system).

Individual purchase decisions 508 are related to one or more profiles 502 and/or actions 504. For example, if an identified shopper purchases a loaf of bread using a promotion offering a discount of 50 cents, the purchase decision 508 is collected at a point-of-sale terminal and associatively stored with the identified shopper in a datastore. Multiple purchase decisions for multiple visits by the shopper may be aggregated into the datastore. Likewise, the purchase decisions for multiple shoppers are also aggregated into the datastore and stored in association with the appropriate shopper's profile and actions.

An indexing engine 510 receives profile information and action information from the datastore 506 and purchasing decisions 508 from point-of-sale systems or associated databases and builds a baseline index of intent 512. The baseline index of intent 512 relates the observed purchase decisions 508 to the profiles 502 and actions 504.

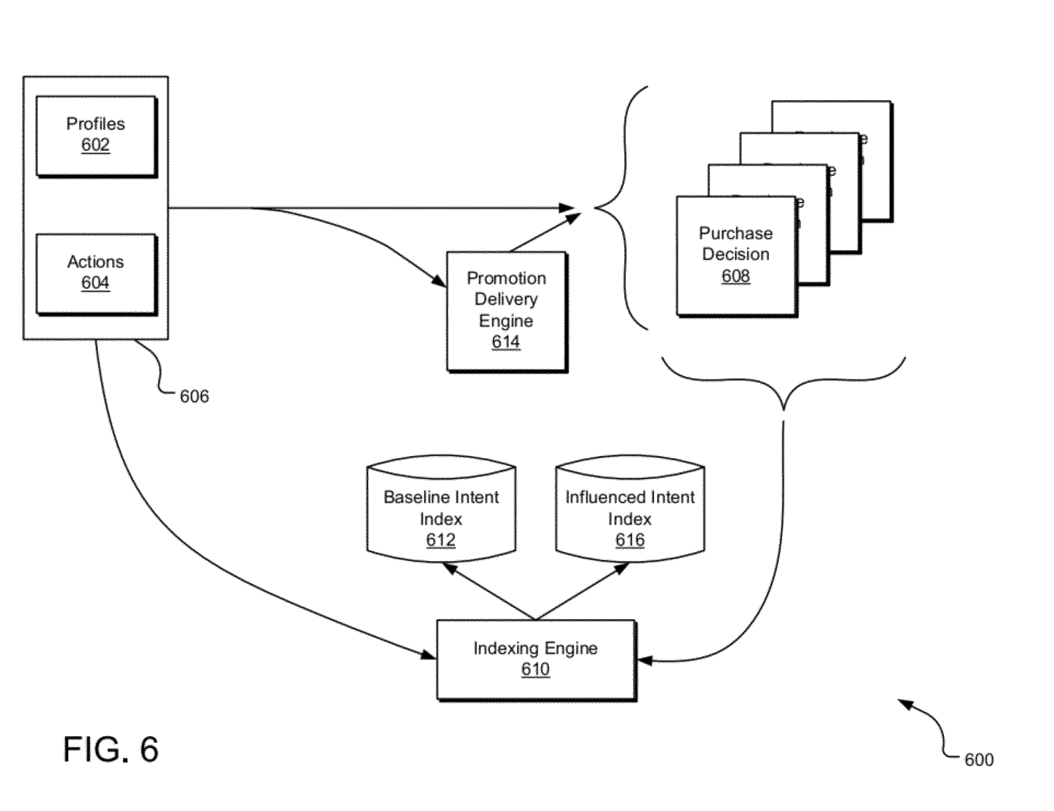

FIG. 6 illustrates an example subsequent phase 600 for determining shopper intent, in which the shopper's purchasing decisions are influenced by offered promotions. Profiles 602 and actions 604 are stored in a datastore 606. Individual purchase decisions 608 are related to one or more profiles 602 and/or actions 604. An indexing engine 610 receives profile information and action information from the datastore 606 and purchasing decisions 608 from point-of-sale systems or associated databases and builds a baseline index of intent 612.

However, in FIG. 6, a promotion delivery engine 614 has begun presenting promotions to the shopper, thereby influencing the shopper's purchase decisions. As a result, the baseline intent index 612 is augmented by an influenced intent index 616, which relates the observed, promotion-influenced purchase decisions 608 to the profiles 602 and actions 604.

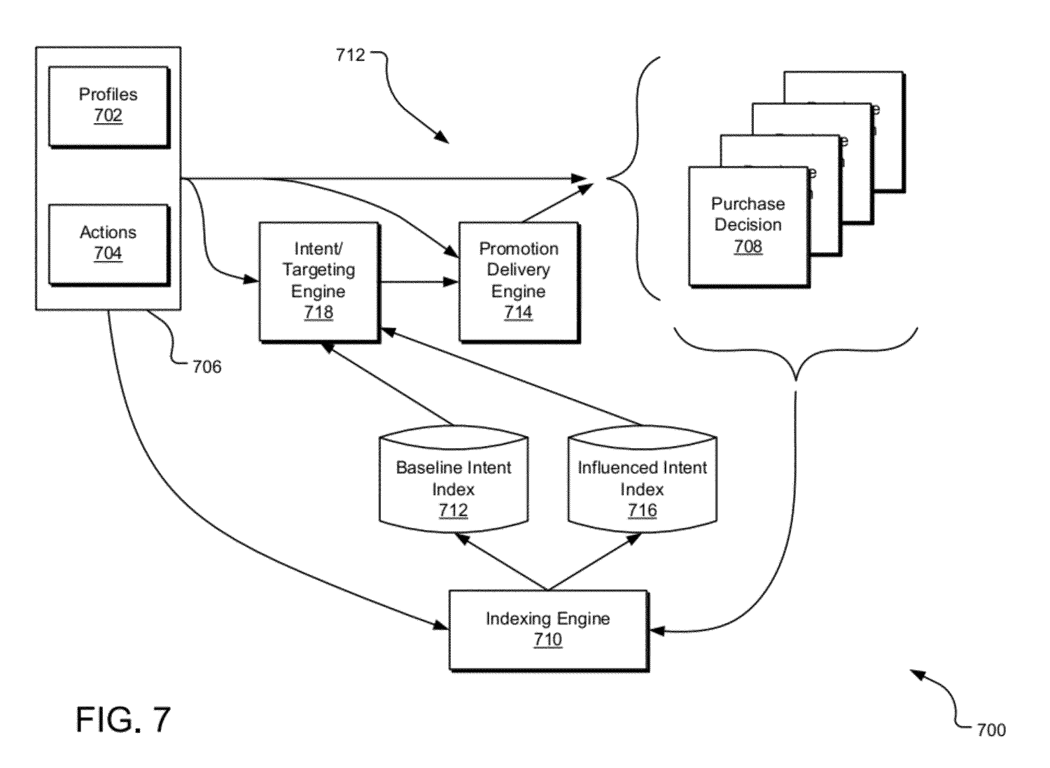

FIG. 7 illustrates yet another example subsequent phase 700 for determining shopper intent, which the promotions can be targeted by inferring a shopper's purchase decision possibilities using intent indices. Profiles 702 and actions 704 are stored in a datastore 706. Individual purchase decisions 708 are related to one or more profiles 702 and/or actions 704. An indexing engine 710 receives profile information and action information from the datastore 706 and purchasing decisions 708 from point-of-sale systems or associated databases and builds a baseline index of intent 712. A promotion delivery engine 714 has also begun presenting promotions to the shopper, thereby influencing the shopper's purchase decisions. As a result, the baseline intent index 712 is augmented by an influenced intent index 716, which relates the observed, promotion-influenced purchase decisions 708 to the profiles 702 and actions 704.

In this subsequent phase 700, as promotion-influenced purchase decisions are related to profiles 702 and actions 704 in the influenced intent index 716, the virtual shopping assistance system can infer an individual shopper's likelihood to response positively to a given promotion. The baseline intent index 712 and the influenced intent index 716 are used by a targeting engine 718 to influence the promotions that are selected for delivery to the individual shopper. Accordingly, more effective promotions can be targeted for an individual shopper based on the effectiveness of past promotions on the shopper, in light of monitored actions 704 and the shopper's profile 702.

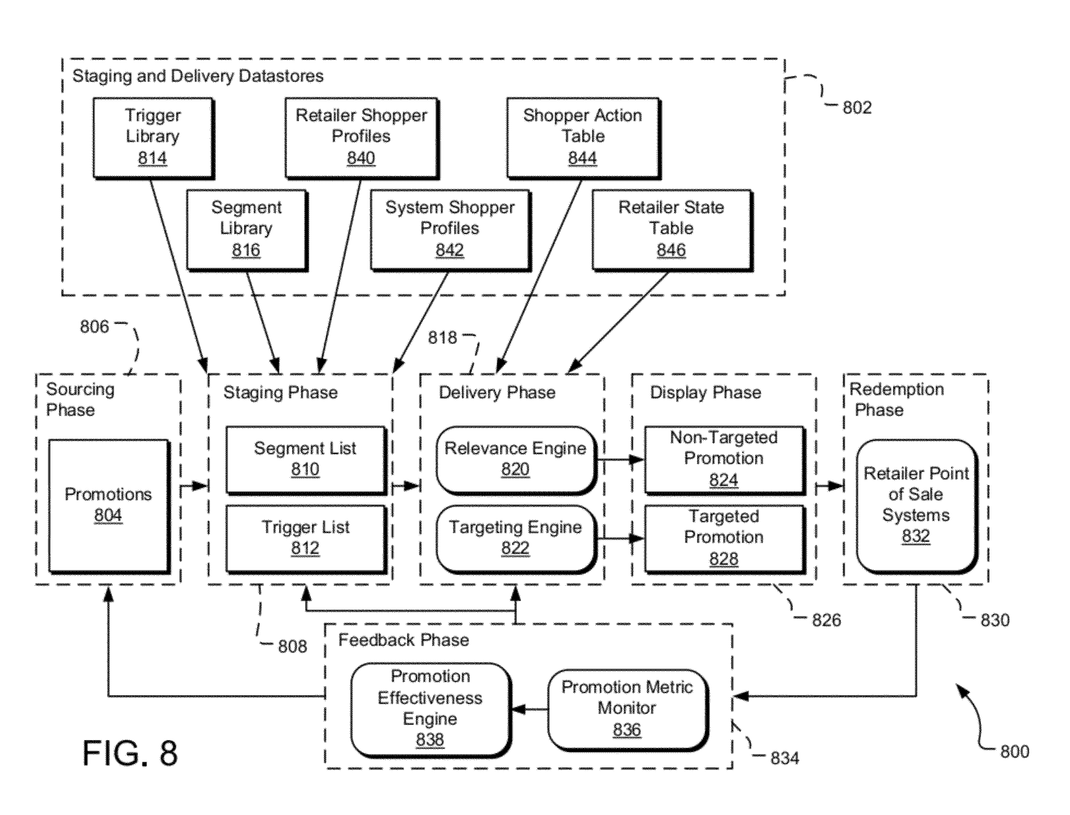

FIG. 8 illustrates a detailed architecture 800 of an example on-premise virtual shopping assistance system. The architecture 800 is described with regard to six primary phases of operation, although the functionality of the on-premise virtual shopping assistance system may be divided into many different logical phase combinations in other implementations. The six phases of operations shown in FIG. 8 include sourcing, staging, delivery, display, redemption, and feedback. These phases combine to provide effective targeting of promotions for individual shoppers to benefit retailers and other vendors and to enhance the relevance of each promotion for each shopper. Various phases of operation receive information from staging and/or delivery datastores 802, although some one or more phases of operation may also provide feedback to update the data recorded in the datastores 802.

Promotions 804 are generally created (e.g., “sourced”) from the information systems of a retailer or other provider (e.g., a third-party promotions distributor) in a sourcing phase 806. In one implementation, the virtual shopping assistance system certifies individual promotions sources and can apply other security functionality in association with its interaction with such sources (e.g., access control, authentication, etc.).

The term “promotions” can refer to a wide variety of promotional offers, including without limitations manufacturer coupons, retailer coupons, temporary price reductions, and basket offers (e.g., when the shopper is offered something to increase their total purchase over a specified threshold). Typically, the promotions 804 will be numerous (e.g., hundreds, thousands, millions) so as to increase the opportunity of finding a promotion that is likely to attract a shopper to execute a related purchase. The source data associated with the promotions 804 includes promotion characteristics, such as discount amount, redemption terms and conditions, related artwork, etc.

The promotions 804 are transferred (“staged”) to a staging phase 808, which adds baseline information to each promotion 804 so that the system can compute targeting and relevance. A purpose of staging is to relate each promotion with its applicable segments and triggers. In one implementation, staging may be implemented as a manual process performed by each retailer or other vendor for each promotion to be delivered through the virtual shopping assistance system. In other implementations, a more automated staging may be performed using staging parameters and rules.

In one implementation, the default configuration is “no segments” and “no triggers,” allowing a promotion to be deliver to any shoppers. In contrast, the staging phase 808 may impose segmentation using internal system data, retailer data, vendor data, or other data. Through segmentation, a named segment is defined based on this data and eligible shoppers are listed within the segment by their shopper identifiers. Similarly, each promotion is related to zero or more triggers that define one or more conditions under which a promotion is to be delivered.

For each promotion, two lists are created in one implementation: (1) a segment list 810 describing which shoppers are eligible for the promotion; and (2) a trigger list 812 describing the conditions under which the promotion is to be delivered to the shopper. The lists are built from a trigger library 814 and a segment library 816 that contain various types of triggers and segments and their respective definitions. Trigger definitions may be entered via a retailer dashboard system, although other input systems may be employed, such as retailer-accessible web services, server-resident definition files. An example trigger definition is provided below:

Type=BarcodeScan, CategoryID=L5 00123, OfferID=000012345

which specifies that an offer identified by the ID “000012345” may be presented to a shopper if a barcode is scanned by the shopper and the associated product is in a product category identified by the ID “L5 00123”.

A market segment represents a subset of a market, with each segment comprising people and/or organizations sharing one or more characteristics that suggest they may be interested in the same product or service. The segment list 810 provides a set of segments as applied to the goods/services provided by the retailers and pertaining to the individual shoppers each retailer is tracking. The segment list 810 can be generated on the basis of a shopper's profile, the retailer's own database containing profile information on the shopper, a combination of the two, or in combination with third-party shopper profile sources. For example, a segment list may be generated by a retailer's existing segmentation tools based on its own customer data and third-party data and then transmitted to the virtual shopping assistance system with a list of eligible customer identifiers. In one implementation, a segment list includes a listing of associated values, such as two or more identifiers for a segment, a product, a service, a promotion, etc.

The trigger list 812 includes a set of actions and/or states and the triggers corresponding to these actions and/or states. For example, a trigger list entry may define a rule for a particular promotion and a selected segment, such as “if a keyword X is searched by a shopper in the selected segment and the available inventory is greater than a threshold Y of items, then offer the particular promotion.” In one implementation, the segment list 810 and the trigger list 812 are created at the time the promotion is input to the virtual shopping assistance system and maintained for the duration of the promotion, although in other implementations, the segment list 810 and the trigger list 812 may be dynamically updated and adjusted based on a variety of inputs and feedbacks.

Tables 1 and 2 list some examples trigger rule types that may be used (three rules based on actions and one rule based on state) in a virtual shopping assistance system, although other triggers rules may also be employed:

TABLE 1
Example Action Type Trigger Rules

| | |
|---|---|
| Action Type | Trigger Rule Possibilities |
| Location | In physical store or virtual store, near an item, approaching |
| | a location, lingering at a location |
| Search/Scan | Item, keyword or category searched for through mobile |
| | device or kiosk, item scanned using bar code scanner |
| List | Item, keyword, category on the shopper's shopping list |

TABLE 2
Example State Type Trigger Rules

| | |
|---|---|
| State Type | Trigger Rule Possibilities |
| Product | Over-stocked or under-stocked |
| Freshness | Fresh, expiring, non-perishable |

Delivery of promotions pertains to determining which promotions to deliver, when to deliver them, and in what order. In one implementation, two methods of delivery determination are implemented. The first method is termed “targeting” and enables the delivery of promotions to subsets (“segments”) of shoppers under limited conditions. The second method is termed “relevance” and enables the sorting of promotions for presentation to shoppers based on the determined relevance of the promotion to each individual shopper.

A delivery phase 818 operates to effect real-time delivery of promotions to individual shoppers and is managed independently by a relevance engine 820 and a targeting engine 822, although other implementations may employ a cooperative relationship between the relevance engine 820 and the targeting engine 822. For example, targeting information from the targeting engine 822 may be used as input to the relevance engine 822. The delivery phase 818 can access a variety of information, including without limitation shopper profiles 840 maintained by the retailer, shopper profiles 842 maintained by the virtual shopping assistance system, monitored actions of the shopper (stored in a shopper action table 844), and the state of the retailer (stored in a retailer state table 846).

The relevance engine 820 examines one or more of shopper profile information (e.g., past shopping behavior, residential address, etc.), monitored actions of each shopper (e.g., real-time location, in-store searches, shopping list content and modifications, etc.), and retailer states (e.g., inventory, store hours, to compute a relevance score and to drive the presentation order of non-targeted promotions 824 to a shopper in a display phase 826. The relevance score represents a measure of how relevant a particular offer is to the shopper and influences the priority or presentation order of a promotional offer to a shopper if it is more relevant. For example, the higher the relevance score is for a given promotion to a given shopper, the higher or more prominently on the shopper's promotion list the given promotion will appear. In one implementation, the relevance algorithm may be similar to that employed in Web search algorithms, although the presence of previously-unavailable information (such as retail state information, shopping list data, and action data) may influence the algorithm and therefore the relevance results in the delivery phase 818.

Consider a shopper who is shopping for “shampoo” on his or her shopping list. The promotions 804 include a promotion (e.g., an e-coupon) for a certain brand of conditioner. The relevance engine 820 may consider how likely the shopper is to buy the conditioner if the coupon is presented to him or her. Tables 3 and 4 provide example assessments based on the shoppers profile and actions and the store's state, assuming a female shopper with certain characteristics):

TABLE 3
Example Profile Relevance Factors

| | | Profile |
|---|---|---|
| | | Relevance |
| Profile Type | Rules | Factors |
| Personal Profile | 5 points for being a female | 5 |
| Promotion History | 3 points for having redeemed greater | 0 |
| | than 3 coupons in the last week | |
| Basket History | (not available) | 0 |
| List history | 8 points for having hair products on | 8 |
| | greater than 40% of her shopping lists | |
| Search/scan history | 4 points for having searched or | 0 |
| | scanned for greater than 5 products in | |
| | the associated category | |
| % of Available Score | | 65% |

TABLE 4
Example Trigger Relevance Factors

| | | Trigger |
|---|---|---|
| | | Relevance |
| Action Type | Rules | Factors |
| Location | 5 points for being in the health and | 5 |
| | beauty department | |
| List | 7 points for having the category | 7 |
| | “shampoo” on shopping list | |
| Search/scan | 8 points for doing a search/scan for | 0 |
| | conditioner | |
| % of Available Score | | 60% |

In the example given by Tables 3 and 4, the shopper's profile relevance score for the promotion is 65% and her trigger relevance score is 60%. The relevance engine 820 of the delivery phase 818 therefore may conclude that (1) the shopper is likely to positively respond to the promotion if it is presented to her, and (2) her current actions (being in the health and beauty department) further support the likelihood of a positive response. Accordingly, the relevance engine 820 would present the promotion to the shopper in a higher priority (e.g., higher or otherwise more prominent placement) as compared to other lower scoring promotions.

The targeting engine 822 also examines the monitored actions of each shopper, along with retailer state information, to determine when (e.g., in response to which actions) a targeted promotion should be delivered to that shopper, subject to segment, trigger, and retailer state information. For example, if the shopper is a member of a segment associated with a product, the display phase 826 may be configured to present an associated targeted promotion 828 when the shopper is within 10 feet of the promoted product. In another example, a promotion X applicable to a segment A consisting of males 30-35 may be triggered when a user searches for “chips” while in the store. In this case, the targeting engine 822 would monitor the virtual shopping assistance system's search functionality for the keyword “chips” and would trigger deliver of the promotion X if the searching shopper is classified in segment A. Profile information may also be employed to inform the targeting engine 822. Furthermore,

The display phase 826 presents one or more promotions to individual on-premise shoppers. Although the term “display” is used in the display phase 826, any type of presentation may be employed, including without limitation visual, audial, olfactory, tactile, and printed presentations, and/or combinations thereof. Example promotion presentations may include without limitation:
Browse & Search All Offers—Gives the shopper a place to easily manage the way coupons are found prior to arriving at the store or while in the store; the selection of coupons is very large and is browse-able, categorized, and searchable.
Suggested Offers—Present the more relevant coupons to the shopper
Assist Shopping Decision at Shelf—Present coupons pertaining to items in the shopper's current proximity
Enhanced Offers—Present coupons with an enhanced sense of value to the shopper

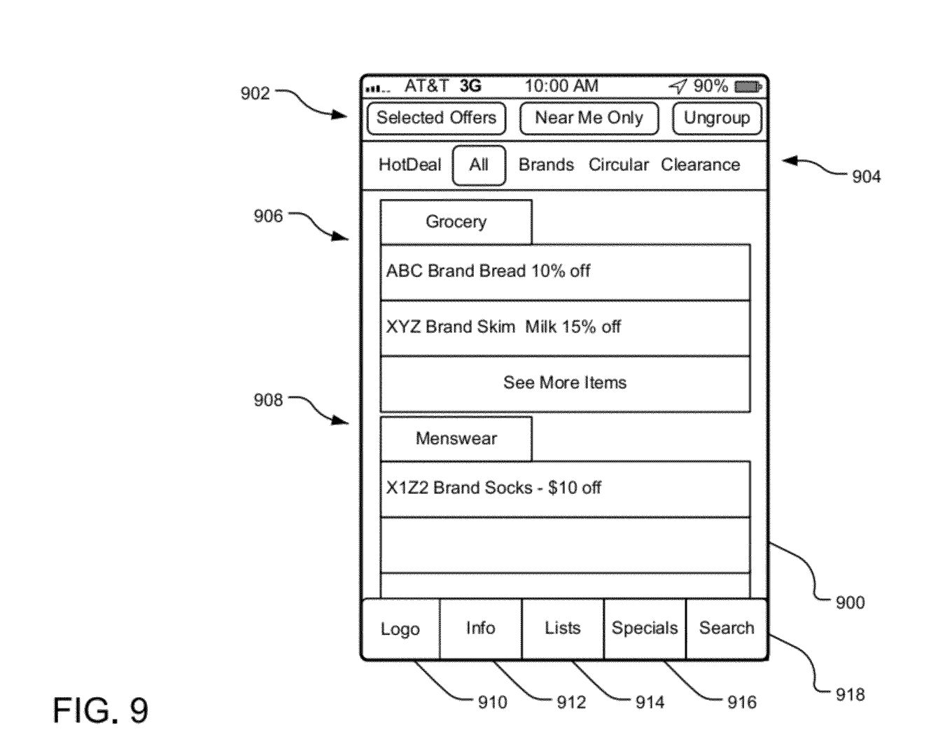

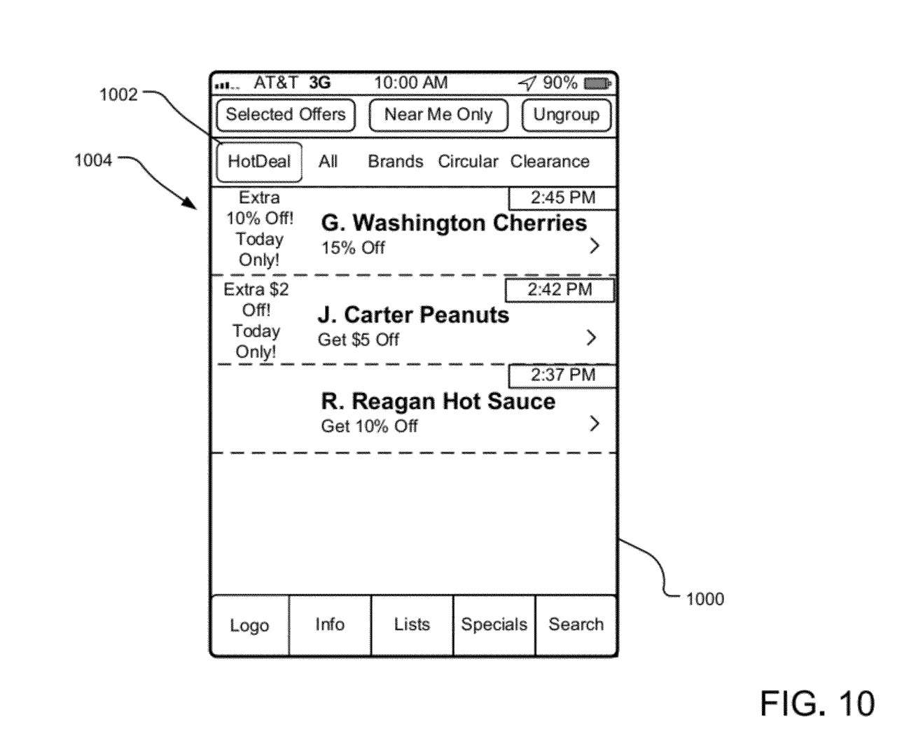

Within these and other types of promotion presentations, targeted promotions 828 may have different objectives as compared to non-targeted promotions 824, which may influence how a promotion should be presented to the an individual shopper. For example, a relevant consideration for presenting a targeted promotion 828 may be to cause the shopper to look at the presentation of the targeted promotion 828 at the time of delivery or time of purchase decision. In contrast, a relevant consideration for presenting a non-targeted promotion 824 may be to emphasize the most relevant promotions in the most prominent way. In one perspective, targeted promotions 828 may give priority to interests of the retailer or other vendors to trigger a sale, while non-targeted promotions 824 may give priority to interests of the shopper to enhance ease of use, although it should be understood that other perspectives consider various benefits to many different parties of shopping transactions. Example user interfaces for promotion presentation are provided in FIGS. 9 and 10.

A redemption phase 830 manages the redemption of promotional offers. In many implementations, the redemption phase 830 may depend on a retailer's point-of-sale systems 832, although other redemption mechanisms may be employed including without limitation on-line redemption systems, post-purchase redemption systems (e.g., for mailing or emailing in a proof-of-purchase or receiving a rebate when registering the purchase with the manufacturer), etc. The retailer point-of-sale systems 832 interact with a virtual shopping assistance server to authorize the grant of the promotional benefit to the shopper and to record the redemption. For example, if the promotion is presented as an e-coupon, a point-of-sale system 832 can connect the e-coupon with a purchase of the associated product by the shopper and therefore apply the promotional benefit (e.g., a discount) to the purchase. Some other promotion types are also contemplated for execution at a point-of-sale system 832, such as non-coupon promotions (e.g., loyalty program members who receive discounts at check out for certain items). The virtual shopping assistance server maintains a list of the promotions that are valid for each shopper and synchronizes that list with the point-of-sale system whenever the shopper uses (e.g., clips or unclips) an e-coupon. At checkout, the point-of-sale system 832 references its own internal list of applicable promotions for the given shopper (e.g., as identified to the point-of-sales system according to the shopper's loyalty program identification number or some other identifier) for each item presented for checkout by the shopper to determine whether the item has a qualifying promotion associated with the shopper. If so, the promotion is applied by the point-of-sale system 832 during the checkout process.

Of several types of promotions, e-coupons (for example) may be selected to be redeemed. Other promotions act more like advertisements—the promotion is used to entice the shopper to make a purchase of a particular item, but the shopper receives the discount whether the shopper saw the promotion or not. Selected e-coupon-like promotions may be displayed in a “Selected” list.

Information from the completed checkout is passed back to the virtual shopping assistance server and used in a feedback phase 834. A promotion metric monitor 836 evaluates and records certain usage parameters (e.g., the number of promotion presentations, the click-through rate, the redemption rate for each promotional offer). The promotion effectiveness engine 838 analyzes the data in non-real-time and creates statistical profiles of how effectively the relevance engine 820 and the targeting engine 822 have achieve desired usage goals (e.g., set by the retailer or other vendors). Such usage parameters may be fed back into the promotion sources in the source phase 806, the segment lists 810 and trigger lists 812 in the staging phase 808, and the relevance engine 820 and the targeting engine 822 in the delivery phase 818. In this manner, the usage parameters can be used to improve how the targeting and deliver parameters and the targeting and relevance algorithms are adjusted during the system lifecycle.

FIG. 9 illustrates an example promotional offer interface 900. The top interface bar 902 provides controls that manage three primary functions: (1) Selected Offers—present a list of selected promotions; (2) Near Me Only—present only promotions pertaining to items that are in the shopper's proximity; and (3) Group/Ungroup—group or ungroup the presentation. In one implementation, products on a promotional list may be grouped by product/service category or by other grouping types.

A filter bar 904 enables selections among five different filter types, although other types may also be employed.

A “HotDeal” control displays triggered promotions. The triggered promotions are presented in the order in which they were triggered during the shopper's visit to the retail establishment. In one implementation, a HotDeal promotion is presented to a shopper having an appropriate profile and performing one or more appropriate detected on-premises actions. Each triggered promotion has a notification that is associated with a trigger time or event (e.g., proximity to an item). Some triggered promotions may offer an enhanced level of value, subject to a condition, such as for a limited time, dependent on a number of items purchased, valid only while the shopper remains in the proximity of the promoted item. Some triggered promotions may also be time sensitive, terminating or altering in value after a period of time.

An “All” control displays all available promotions, whether triggered or not. Promotions are ordered according to relevance and may be grouped by categories, which may also be ordered according to relevance.

A “Brands” control displays groups of promotions according to shared branding (e.g., offered by the same consumer packaged goods (CPG) vendor). A “Circular” control displays promotions that were also advertised in retailer or newspaper published circular advertisements. A “Clearance” control displays all promotions pertaining to items that are on sale. In some implementations, the circular and clearance groupings may be custom-implemented by the retailer.

The user interface 900 also provides a logo display 910, a control 912 for retailer information (e.g., hours, phone numbers, location, URL, etc.), a control 914 to access the shopper's shopping lists, a control 916 to access other retailer-promoted or CPG-promoted specials, and a control 918 to execute a product, keyword, or category search through the retailer's product database or an external database.

FIG. 10 illustrates another example promotional offer interface 1000. The “HotDeal” filter control 1002 is selected and the promotions 1004 are displayed in the promotional offer interface 1000, including two with enhanced, time-sensitive promotional values.

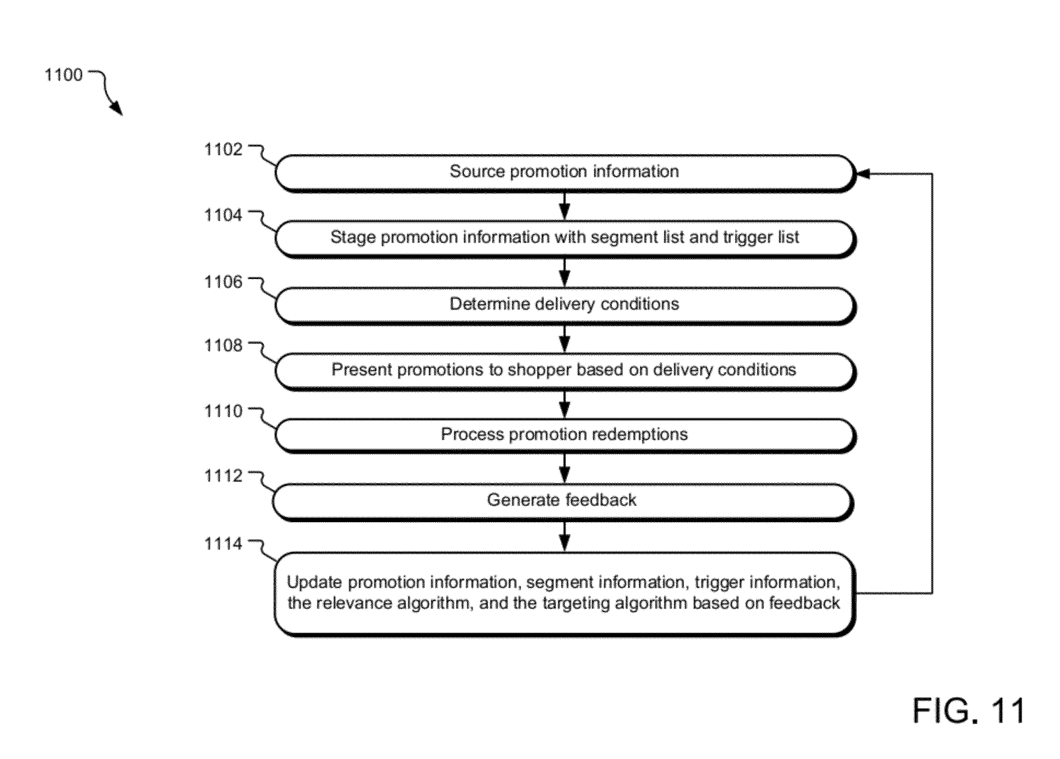

FIG. 11 illustrates example operations 1100 for providing on-premise virtual shopping assistance. A sourcing operation 1102 sources promotion information, such as from a retailer's information systems or a third-party promotion service. A staging operation 1104 stages the promotion information with segmentation information and trigger information, which support the determination of delivery conditions in a delivery operation 1106. In one implementation, delivery conditions are in the form of relevance ordering and targeting rules.

A presentation operation 1108 presents the targeted and/or non-targeted promotions to the shopper based on the delivery conditions. A redemption operation 1110 processes the redemption of promotions, such as at a point-of-sale system. A feedback operation 1112 generates feedback, such as promotion metrics and effectiveness metrics, which are fed back to the sourcing operation 1102, the staging operation 1104, and the delivery operation 1106 to update promotion information, segment information, trigger information, one or more relevance algorithms, and one or more targeting algorithms. Processing iterates back to the sourcing operation 1102.

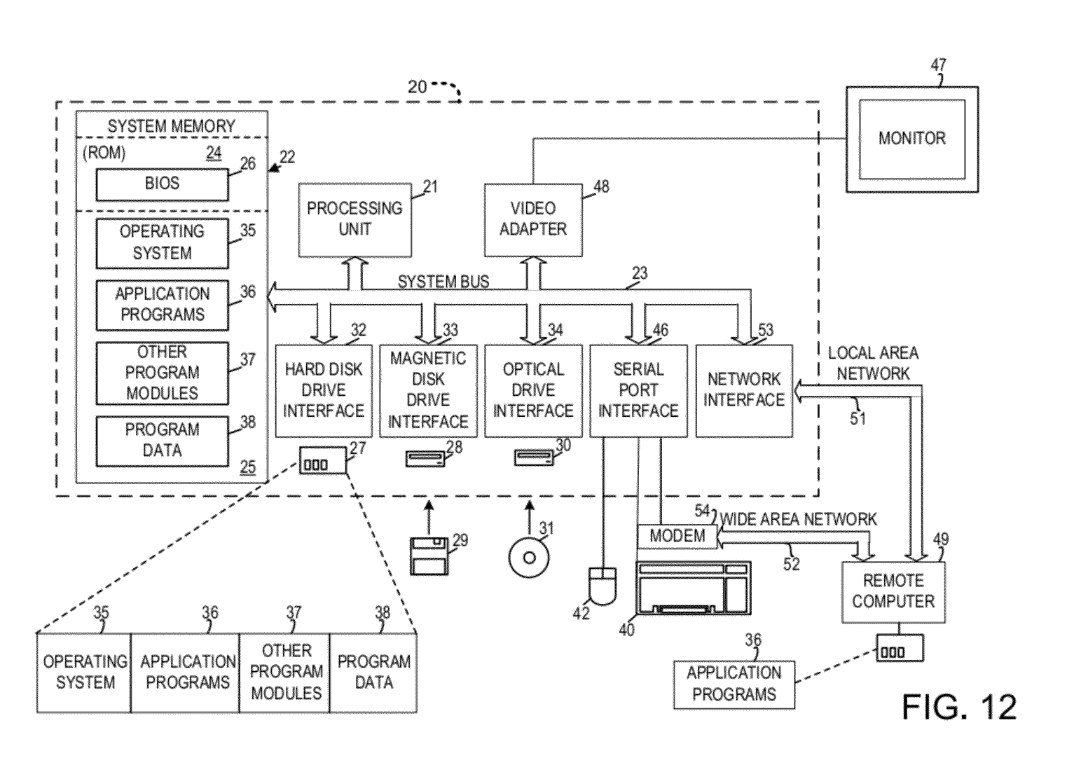

FIG. 12 illustrates an example system that may be useful in implementing the described technology. The example hardware and operating environment of FIG. 12 for implementing the described technology includes a computing device, such as general purpose computing device in the form of a gaming console or computer 20, a mobile telephone, a personal data assistant (PDA), a set top box, or other type of computing device. In the implementation of FIG. 12, for example, the computer 20 includes a processing unit 21, a system memory 22, and a system bus 23 that operatively couples various system components including the system memory to the processing unit 21. There may be only one or there may be more than one processing unit 21, such that the processor of computer 20 comprises a single central-processing unit (CPU), or a plurality of processing units, commonly referred to as a parallel processing environment. The computer 20 may be a conventional computer, a distributed computer, or any other type of computer; the invention is not so limited.

The system bus 23 may be any of several types of bus structures including a memory bus or memory controller, a peripheral bus, a switched fabric, point-to-point connections, and a local bus using any of a variety of bus architectures. The system memory may also be referred to as simply the memory, and includes read only memory (ROM) 24 and random access memory (RAM) 25. A basic input/output system (BIOS) 26, containing the basic routines that help to transfer information between elements within the computer 20, such as during start-up, is stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, a DVD, or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, random access memories (RAMs), read only memories (ROMs), and the like, may be used in the example operating environment.

A number of program modules may be stored on the hard disk, magnetic disk 29, optical disk 31, ROM 24, or RAM 25, including an operating system 35, one or more application programs 36, other program modules 37, and program data 38. A user may enter commands and information into the personal computer 20 through input devices such as a keyboard 40 and pointing device 42. Other input devices (not shown) may include a microphone, joystick, game pad, satellite dish, scanner, or the like. These and other input devices are often connected to the processing unit 21 through a serial port interface 46 that is coupled to the system bus, but may be connected by other interfaces, such as a parallel port, game port, or a universal serial bus (USB). A monitor 47 or other type of display device is also connected to the system bus 23 via an interface, such as a video adapter 48. In addition to the monitor, computers typically include other peripheral output devices (not shown), such as speakers and printers.

The computer 20 may operate in a networked environment using logical connections to one or more remote computers, such as remote computer 49. These logical connections are achieved by a communication device coupled to or a part of the computer 20; the invention is not limited to a particular type of communications device. The remote computer 49 may be another computer, a server, a router, a network PC, a client, a peer device or other common network node, and typically includes many or all of the elements described above relative to the computer 20, although only a memory storage device 60 has been illustrated in FIG. 12. The logical connections depicted in FIG. 12 include a local-area network (LAN) 51 and a wide-area network (WAN) 52. Such networking environments are commonplace in office networks, enterprise-wide computer networks, intranets and the Internet, which are all types of networks.

When used in a LAN-networking environment, the computer 20 is connected to the local network 51 through a network interface or adapter 53, which is one type of communications device. When used in a WAN-networking environment, the computer 20 typically includes a modem 54, a network adapter, a type of communications device, or any other type of communications device for establishing communications over the wide area network 52. The modem 54, which may be internal or external, is connected to the system bus 23 via the serial port interface 46. In a networked environment, program modules depicted relative to the personal computer 20, or portions thereof, may be stored in the remote memory storage device. It is appreciated that the network connections shown are example and other means of and communications devices for establishing a communications link between the computers may be used.

In an example implementation, a virtual shopping assistance server, a location detector, a routing engine, a promotion engine, and other modules and services may be embodied by instructions stored in memory 22 and/or storage devices 29 or 31 and processed by the processing unit 21. Inventory data, shopping lists, personalization and location parameters pertaining to an individual shopper, and other data may be stored in memory 22 and/or storage devices 29 or 31 as persistent datastores.

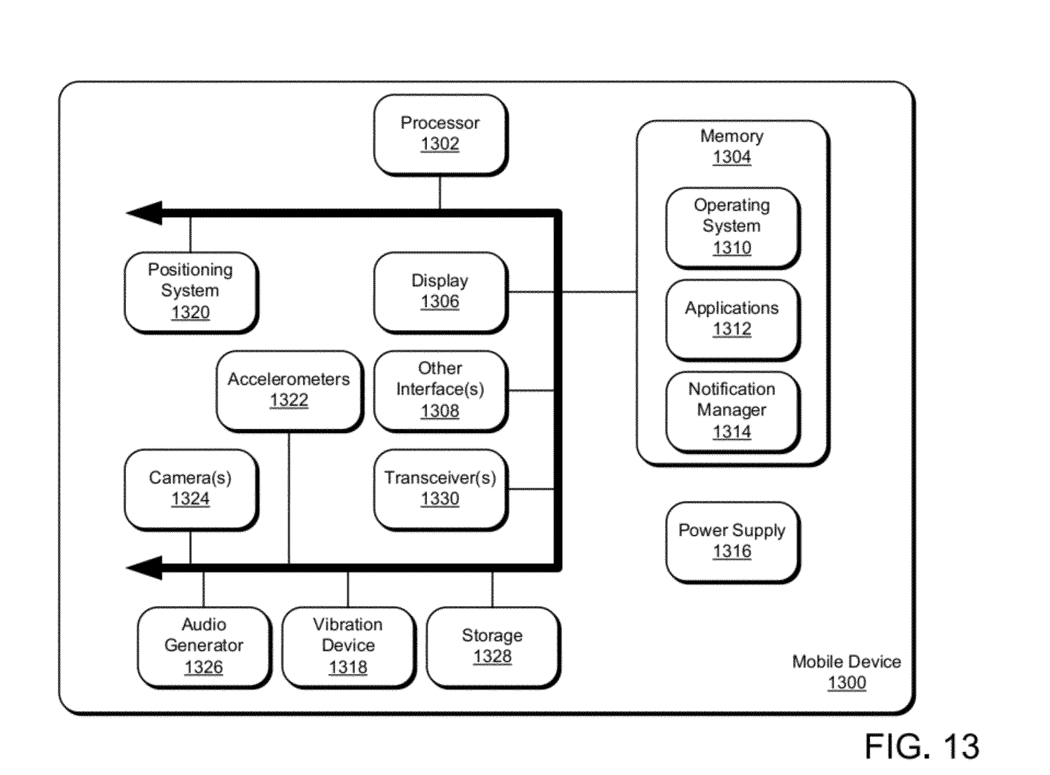

FIG. 13 illustrates another example system (labeled as a mobile device 1300) that may be useful in implementing the described technology. The mobile device 1300 includes a processor 1302, a memory 1304, a display 1306 (e.g., a touchscreen display), and other interfaces 1308 (e.g., a keyboard). The memory 1304 generally includes both volatile memory (e.g., RAM) and non-volatile memory (e.g., flash memory). An operating system 1310, such as the Microsoft Windows® Phone 7 operating system, resides in the memory 1304 and is executed by the processor 1302, although it should be understood that other operating systems may be employed.

One or more application programs 1312 are loaded in the memory 1304 and executed on the operating system 1310 by the processor 1302. Examples of applications 1312 include without limitation email programs, scheduling programs, personal information managers, Internet browsing programs, multimedia player applications, etc. A notification manager 1314 is also loaded in the memory 1304 and is executed by the processor 1302 to present notifications to the user. For example, when a promotion is triggered and presented to the shopper, the notification manager 1314 can cause the mobile device 1300 to beep or vibrate (via the vibration device 1318) and display the promotion on the display 1306.

The mobile device 1300 includes a power supply 1316, which is powered by one or more batteries or other power sources and which provides power to other components of the mobile device 1300. The power supply 1316 may also be connected to an external power source that overrides or recharges the built-in batteries or other power sources.

The mobile device 1300 includes one or more communication transceivers 1330 to provide network connectivity (e.g., mobile phone network, Wi-Fi®, BlueTooth®, etc.). The mobile device 1300 also includes various other components, such as a positioning system 1320 (e.g., a global positioning satellite transceiver), one or more accelerometers 1322, one or more cameras 1324, an audio generator 1326 (e.g., an audio amplifier and speaker and/or audio jack), and additional storage 1328. Other configurations may also be employed.

In an example implementation, a virtual shopping assistance client, a location detector, and other modules and services may be embodied by instructions stored in memory 1304 and/or storage devices 1328 and processed by the processing unit 1302. Personalization and location parameters pertaining to an individual shopper, and other data may be stored in memory 1304 and/or storage devices 1328 as persistent datastores.

Some embodiments may comprise an article of manufacture. An article of manufacture may comprise a storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one embodiment, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

The embodiments of the invention described herein are implemented as logical steps in one or more computer systems. The logical operations of the present invention are implemented (1) as a sequence of processor-implemented steps executing in one or more computer systems and (2) as interconnected machine or circuit modules within one or more computer systems. The implementation is a matter of choice, dependent on the performance requirements of the computer system implementing the invention. Accordingly, the logical operations making up the embodiments of the invention described herein are referred to variously as operations, steps, objects, or modules. Furthermore, it should be understood that logical operations may be performed in any order, unless explicitly claimed otherwise or a specific order is inherently necessitated by the claim language.

Although the subject matter has been described in language specific to structure features and/or methodological acts, it is to be understood that the subject matter defined in the appended claims is not necessarily limited to the specific features or acts described above. Rather the specific features and acts described above are disclosed as example forms of implementing the claims.

The above specification, examples, and data provide a complete description of the structure and use of exemplary implementations of the described technology. Since many implementations can be made without departing from the spirit and scope of the described technology, the invention resides in the claims hereinafter appended. Furthermore, structural features of the different embodiments may be combined in yet another embodiment without departing from the recited claims.

What is claimed is:

1. A method comprising:
identifying an available promotion corresponding to an item available for purchase by an on-premise shopper of a shopping establishment;
determining eligibility of the on-premise shopper for the identified promotion based on one or more profile parameters of the on-premise shopper;
monitoring at least one on-premise action of the on-premise shopper;
determining a delivery condition for the identified promotion and the on-premise shopper, based on the at least one monitored, on-premise action of the on-premise shopper; and
presenting the identified promotion to the on-premise shopper in accordance with the delivery condition.

2. The method of claim 1 wherein the identified promotion is associated with a market segment and the operation of determining an eligibility of an on-premise shopper comprises:
evaluating the one or more profile parameters to determine whether the on-premise shopper can be classified in the market segment associated with the identified promotion.

3. The method of claim 1 wherein the operation of determining a delivery condition comprises:
computing a relevance score between the identified promotion and the on-premise shopper based on one or more profile parameters associated with the on-premise shopper.

4. The method of claim 1 wherein the operation of determining a delivery condition comprises:
computing a relevance score between the identified promotion and the on-premise shopper based on the at least one monitored, on-premise action of the on-premise shopper, the delivery condition governing a level of prominence with which the identified promotion is presented to the on-premise shopper.

5. The method of claim 1 wherein the operation of determining a delivery condition comprises:
computing a relevance score between the identified promotion and the on-premise shopper based on the at least one monitored, on-premise action of the on-premise shopper, the delivery condition governing a level of prominence with which the identified promotion is presented to the on-premise shopper.

6. The method of claim 1 wherein the operation of determining a delivery condition comprises:
computing a trigger associated with the identified promotion and the on-premise shopper based on the at least one monitored, on-premise action of the on-premise shopper, the delivery condition governing when the identified promotion is presented to the on-premise shopper.

7. The method of claim 1 wherein the operation of determining a delivery condition comprises:
computing a trigger associated with the identified promotion and the on-premise shopper based on the at least one shopping establishment state, the delivery condition governing when the identified promotion is presented to the on-premise shopper.

8. The method of claim 7 wherein the at least one shopping establishment state includes an inventory metric for the item associated with the identified promotion.

9. One or more computer-readable storage media encoding computer-executable instructions for executing on a computer system a computer process, the computer process comprising:
identifying an available promotion corresponding to an item;
determining eligibility of a visitor for the identified promotion based on one or more profile parameters of the visitor;
determining a delivery condition for the identified promotion and the visitor, based on at least one monitored, on-premise action of the visitor; and
presenting the identified promotion to the visitor in accordance with the delivery condition.

10. The one or more computer-readable storage media of claim 9 wherein the identified promotion is associated with a market segment and the operation of determining an eligibility of a visitor comprises:
evaluating the one or more profile parameters to determine whether the visitor can be classified in the market segment associated with the identified promotion.

11. The one or more computer-readable storage media of claim 9 wherein the operation of determining a delivery condition comprises:
computing a relevance score between the identified promotion and the visitor based on one or more profile parameters associated with the visitor.

12. The one or more computer-readable storage media of claim 9 wherein the operation of determining a delivery condition comprises:
computing a relevance score between the identified promotion and the visitor based on the at least one monitored, on-premise action of the visitor, the delivery condition governing a level of prominence with which the identified promotion is presented to the visitor.

13. The one or more computer-readable storage media of claim 9 wherein the operation of determining a delivery condition comprises:
computing a relevance score between the identified promotion and the visitor based on the at least one monitored, on-premise action of the visitor, the delivery condition governing a level of prominence with which the identified promotion is presented to the visitor.

14. The one or more computer-readable storage media of claim 9 wherein the operation of determining a delivery condition comprises:
computing a trigger associated with the identified promotion and the visitor based on the at least one monitored, on-premise action of the visitor, the delivery condition governing when the identified promotion is presented to the visitor.

15. The one or more computer-readable storage media of claim 9 wherein the operation of determining a delivery condition comprises:
computing a trigger associated with the identified promotion and the visitor based on the at least one visited establishment state, the delivery condition governing when the identified promotion is presented to the visitor.

16. The one or more computer-readable storage media of claim 15 wherein the at least one visited establishment state includes an inventory metric for the item associated with the identified promotion.

17. A system comprising:
a datasource configured to identify an available promotion corresponding to an item;
a relevance engine configured to determine eligibility of a visitor for the identified promotion based on one or more profile parameters of the visitor and to determine a delivery condition for the identified promotion and the visitor, based on at least one monitored, on-premise action of the visitor; and
a presentation device configured to present the identified promotion to the visitor in accordance with the delivery condition.

18. The system of claim 17 wherein the relevance engine is further configured to compute a relevance score between the identified promotion and the visitor based on one or more profile parameters associated with the visitor.

19. The system of claim 17 wherein the relevance engine is further configured to compute a relevance score between the identified promotion and the visitor based on the at least one monitored, on-premise action of the visitor, the delivery condition governing a level of prominence with which the identified promotion is presented to the visitor.

20. The system of claim 17 further comprising:
a targeting engine configured to compute a trigger associated with the identified promotion and the visitor based on the at least one monitored, on-premise action of the visitor, the trigger governing when the identified promotion is presented to the visitor.
